(19) United States
(12) Patent Application Publication
(10) Pub. No.: US 2017/0180149 A1
(43) Pub. Date: Jun. 22, 2017

(54) Methods and Systems for Identifying Smart Objects to a Control Device

(71) Applicant: QUALCOMM Incorporated, San Diego, CA (US)

(72) Inventors: Richard Joseph McConnell, Rancho Cucamonga, CA (US); Daniel Chikami, Cypress, CA (US); Troy Li, Irvine, CA (US); Scott Scigliano, Orange, CA (US); Charles Chang-I Wang, Irvine, CA (US); Thomas Williams, Irvine, CA (US)

(21) Appl. No.: 14/975,954

(22) Filed: Dec. 21, 2015

(51) Int. Cl. H04L 12/28; G05B 15/02

(52) U.S. Cl. CPC H04L 12/2809; G05B 15/02; H04L 2012/2841

(57) ABSTRACT

The various embodiments include methods and systems for facilitating the configuration of smart objects within a wireless communication system by leveraging the microphonic effect to enable a user to identify each smart object to a control device. By configuring the control device to monitor wireless signals from a plurality of smart objects for small modulations due to the microphonic effect from a user tap on a particular smart object, the control device may recognize a particular smart device to be configured. By coordinating the monitoring for small modulations in received signals with a user interface for registering smart objects, various embodiments provide a simple mechanism by which users can correlate smart objects to corresponding icons or object names in a control interface. The various embodiments enable a user to complete the onboarding a smart objects with a control device without requiring the need to enter information into a user interface.

### BACKGROUND

Many products and common appliances are being equipped with wireless communication capabilities and processors, turning ordinary devices into “smart” objects and heralding future systems that are frequently referred to as the “Internet of Things” or the “Internet of Everything” For example, a common type of smart object that is growing in popularity is smart light bulbs. Leveraging the wireless network capability of smart light bulbs enables a smart lighting system to be set up by installing such bulbs in ordinary sockets and configuring a control computing devices (e.g., a smartphone) to communicate with and control individual bulbs.

While wireless networks of smart objects will provide users with convenience and new services, the widespread deployment of such technologies will require users to learn how to set up such networks. The process of configuring a wireless network to recognize and control a smart object may involve establishing a communication link between a controller (e.g., a network access point or smartphone) and each smart object, and then correlating the identity of the smart object to a user interface. For example, to set up a smart lighting system, a user interface presented on a controller (e.g., a network access point or smartphone) may need to identify the locations of each smart bulb (e.g., in a map, schematic or list) to enable a user to adjust the light produced by each bulb. The process by which smart objects are added into a network to enable communications and control is sometimes referred to as “onboarding.”

While customers are increasingly familiar with connecting a computer or smart phone to a private wireless network (e.g., WiFi network), the onboarding process is more challenging for smart objects that lack a display and user interface (e.g., keyboard). Smart objects without a display and convenient user interface are sometimes referred to as “headless devices.” Headless devices require special procedures or the use of another computing device to complete the onboarding process. Thus, on boarding of headless smart objects can be intimidating or frustrating to for customers who are uncomfortable with technology. Thus, to enable the widespread deployment of smart objects and the Internet of Things, simple and convenient onboarding procedures are desirable.

### SUMMARY

The various embodiments include methods and systems for facilitating the configuration of smart objects within a wireless communication system by leveraging the microphonic effect to enable a user to identify each smart object to a control device. In various embodiments, associating a smart object with a control device in a wireless network may include monitoring wireless signals received from a plurality of smart objects to detect microphonic modulations in wireless signals transmitted by one of the plurality of smart objects, presenting a user interface display requesting a user to identify a control to be associated with one of the plurality of smart objects, receiving a user input identifying a selected control to be associated with one of the plurality of smart objects, and associating the selected control with the one of the plurality of smart objects exhibiting microphonic modulations in transmitted wireless signals. In some embodiments, monitoring wireless signals to detect microphone modulations may be performed after receiving the user input identifying a selected control to be associated with the one of the plurality of smart objects. In some embodiments, the user interface display may include instructions directing the user to tap the one of the plurality of smart objects with which the selected control is to be associated.

Some embodiments may further include establishing communication links with each of the plurality of smart objects prior to monitoring wireless signals received from the plurality of smart objects. In some embodiments, associating the selected control with the one of the plurality of smart objects exhibiting microphonic modulations in transmitted wireless signals may include associating the selected control with a network label of the one of the plurality of smart objects exhibiting microphonic modulations in response to detecting microphonic modulations in wireless signals of the communication link established with the one of the plurality of smart objects.

In some embodiments, receiving a user input identifying a selected control to be associated with one of the plurality of smart objects may include receiving a series of user inputs indicating selecting controls a sequence in which the user will tap the plurality of smart objects, and associating the selected control with the one of the plurality of smart objects exhibiting microphonic modulations in transmitted wireless signals may include sequentially associating each selected control with one of the plurality of smart objects exhibiting microphonic modulations in wireless signals of the established communication links.

In some embodiments, the user interface display may include a map of smart object locations, and associating the selected control with the one of the plurality of smart objects exhibiting microphonic modulations in transmitted wireless signals may include indicating on the map of smart object locations a location of the one of the plurality of smart objects exhibiting microphonic modulations in wireless signals of an established communication link.

Further embodiments include a control device having a transceiver and a processor configured to perform operations of the embodiment methods described herein. Further embodiments include a control device having means for performing functions of the embodiment methods described above. Further embodiments include a non-transitory computer readable storage medium on which are stored processor executable instructions configured to cause a processor to perform operations of the embodiment methods described herein.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a communication system diagram illustrating components of a smart object network including smart objects and control devices suitable for use with various embodiments.

FIG. 1B is a communication system diagram illustrating smart objects coupled to a control device in accordance with various embodiments.

FIG. 1C is a diagram illustrating a modulation of a communication signal of a smart object in accordance with various embodiments.

FIG. 1D is a diagram illustrating a modulation of a communication signal of one of among multiple smart objects in accordance with various embodiments.

FIG. 2A is a functional block diagram illustrating selecting on a control device a smart object for location and control in accordance with various embodiments.

FIG. 2B is a functional block diagram illustrating selecting on a control device a plurality of smart objects for location and control in accordance with various embodiments.

FIG. 3A is a message flow diagram illustrating communication interactions between a control device, access point, and smart objects for discovery.

FIG. 3B is a message flow diagram illustrating communication interactions between a control device, access point, and smart objects for location and control in accordance with various embodiments.

FIG. 4A is a process flow diagram illustrating an embodiment method for associating a smart object with a control.

FIG. 4B is a process flow diagram illustrating an embodiment method for generating changes in a communication signal of a smart object.

FIG. 5 is a process flow diagram illustrating an embodiment method for locating and controlling smart objects with controls in accordance with various embodiments.

FIG. 6 is a component diagram of an example smart object suitable for use with various embodiments.

FIG. 7 is a component diagram of an example mobile computing device suitable for use with various embodiments.

FIG. 8 is a component diagram of an example tablet mobile computing device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments include methods and systems that facilitate the configuration of a smart object within a wireless communication system (referred to herein as “onboarding”) by simplifying the process of identifying a particular smart object to a control device. By configuring the control device to monitor for small modulations in wireless signals from a plurality of smart objects, the control device may recognize a particular smart device that a user has tapped. Such modulations may be caused by the microphonic effect upon transmitter or other circuit elements caused by vibrations from the user's tap on the smart object. By coordinating the monitoring for small modulations with a user interface for registering smart objects, the various embodiments provide a simple mechanism by which users can correlate smart objects to corresponding icons or object names in a control interface. The various embodiments enable a user to complete the process of onboarding a new smart object with a control device without requiring the user to enter more information into a user interface, such as a MAC ID and a label or location for the smart object.

As used herein, the term “control device” may refer to any of a variety of computing devices configured to control smart objects or an Internet of Things. Some non-limiting examples of a control device suitable for use with the various embodiments include wireless network hubs or access points, personal or mobile computing devices, smartphones, tablet computers, laptop computers, palm-top computers, home automation systems, and similar personal electronic devices which include a programmable processor and memory and circuitry for performing operations of the various embodiments.

As used herein, the term “smart object” refers to any device or appliance that includes wireless communication circuitry and a processor configured to connect to a wireless network and include components configured to enable remote control by a control device. In the various embodiments, smart objects may be headless devices in that the devices do not include user interface components (e.g., a display and/or keys). Examples of smart objects include smart light bulbs and smart light emitting diode (LED) lights (also referred to as “smart lighting objects”), smart appliances (e.g., smart washing machines, smart refrigerators, smart toasters, smart thermostats, etc.), automated blinds, and wireless speakers. The adjective “smart” in connection with various devices is used as a shorthand reference to the capability to communicate with a wireless network and receive commands through the network from a control device.

The term “communication network” as used herein may refer interchangeably to organized systems of communication and application-interaction protocols and commands for facilitating device-to-device (e.g., peer-to-peer or “P2P”) and application-to-application communications and interactions. Lower level communication in the communication network (e.g., physical layer) may be implemented using radio frequency (RF) signals that are transmitted and received by devices (smart objects, control devices, etc.) within the network. Higher level communication within the communication network may be implemented using a collection of Application Programming Interfaces (APIs), Software Development Kits (DSKs), and other application or system software that collectively provide standard mechanisms and interface definitions to enable interfacing between controlling and controlled smart objects coupled through a communication network that may be an ad hoc network. The various APIs and SDKs may provide high level access (e.g., from an application layer) to functions that would normally be accessed or controlled at a lower layer in a software architecture. Such functions may include, but are not limited to, ad hoc networking, security, pairing, device discovery, service discovery, platform transparency, radio access control, message formatting, message transmission, message reception and decoding, and so on. Some examples of organizations providing support for peer-to-peer interactivity include the Digital Living Network Alliance (DLNA®), Universal Plug and Play (UPnP) Alliance, and Bonjour. However, these technologies are generally device-centric and tend to operate at the lower layers within a software architecture (e.g., at the Internet Protocol (IP) transport layer).

Determining the location and identity of smart objects in an IoT network, such as networked smart bulbs, may be necessary in some network configurations (e.g., smart lighting systems). Even though smart objects may be connected to the network, a network or controller may need to correlate the identity of a smart bulb (e.g., device or media access control (MAC) identifier) with its location in order to provide some functionalities to a user. For example, in a network of smart bulbs, the control device may need to correctly address each bulb according to location (vs. device ID) in order to achieve desired lighting effects.

Using the example of a smart lighting system, a controller may need to accomplish two tasks as part of onboarding smart bulbs. First, each smart bulb identifier within the network may be associated with the physical location of the smart bulb. However, associating a smart bulb with a location can be difficult, especially when multiple bulbs are present, smart bulbs do not have a user interface, and only a minimum number of user interactions are involved in placing the bulb into operation (e.g., install/replace the bulb). The action of replacing a broken bulb and having the network identify the bulb (e.g., recognize the bulb from address transmissions) maybe straightforward. However, assigning specific behaviors to specific bulbs located in specific positions for controlling lighting effects may require more information to be provided to the control device. This is particularly the point when a smart lighting system is deployed for the first time and there are many smart bulbs to be onboarded at once.

Second, a behavior or control for a particular smart bulb may be associated with the physical location of the smart bulb. However, associating a behavior with a specific bulb presents the difficulty of connecting the behavior options for controlling the bulb to a specific bulb. While a control device may be able to address each smart bulb via the bulb's device ID, linking specific behaviors/controls to a specific smart bulb requires further information from the user.

Current approaches for onboarding smart objects are complicated, requiring a degree of expertise on the part of the installer. If otherwise trivial activities (e.g., changing a light bulb) become difficult or require expert installation, the technology of the Internet of Things is less likely to be widely adopted by consumers, regardless of the potential benefits.

Various embodiments including methods, devices and/or systems that solve the problem of identifying particular smart objects to a control device (e.g., in an Internet of Things network) by leveraging the phenomenon known as “microphonics.” Microphonics is a phenomenon that may be observed in various electronic components that are used in smart objects. For example, for devices such as crystal oscillators, mechanical vibrations may affect characteristics of the signals generated by these devices (e.g., frequency, phase, etc.). The effect may ordinarily result in noise in transmitted wireless signals. For example, when a smart object is tapped, the physical excitation may cause the characteristics of the frequency reference produced by an oscillator in a transceiver of the smart object to generate an altered signal. In other words, the tap may introduce shifts in the frequency and/or phase (e.g., a “ringing” modulation referred to hereinafter as a “ding”) of the transmitted signal. This microphonic induced shift, or ding, in the RF signal is detectable.

In various embodiments, the microphonic “ding” caused by a user tapping a smart object (e.g., a smart bulb) may be used to identify the specific smart object to a control device within the system. Identifying a smart object to the control device in this manner may enable the control device to associate the particular smart object to a location or particular control or behavior for the smart object. In various embodiments, when a user installs a new smart object (e.g., change a smart bulb), the user taps the smart object with a finger. The microphonic effect generated by the tap causes a modulation of the network signal being transmitted from the smart object, such as a low-frequency (e.g., ˜100 KHz) FM modulation. The low frequency FM modulation of the signal can be detected by a specially configured receiver, such as during a time window when the receiver is set up for smart object recognition and control assignment. When the user has informed a control device of the location and/or specific behavior of the smart object that was tapped (either before or after the tap), the control device can correlate the smart object to a location and/or behavior or control options specified by the user.

In various embodiments, a graphical user interface (GUI) may be provided on the control device (or a connected peripheral) to enable users to associate locations, behaviors, and/or controls with smart objects (e.g., smart bulbs). The GUI may identify smart objects to be onboarded, such as in the form of a list or a diagram of a room showing locations and optional behaviors or controls. By tapping a smart object and touching an appropriate icon (or vice versa, e.g. touching an icon and tapping the smart object) the user is able to the smart object to enable the control device to associate the tapped smart object with a user-specified location, behavior or controls.

When a user installs a smart object (e.g., a smart bulb) having an RF transceiver, the smart object will broadcast its device ID (e.g., a MAC ID) or address to the system control device. The smart object may be discovered by the control device and a wireless communication link established. In order to identify/associate the location and/or correct behavior for the smart object, a user may touch a particular control icon in a control GUI (e.g., a smart lighting control screen) presented on the touch screen display of a smart phone. To complete the linkage or association of location/behavior to smart object identifier or network address to a location and/or behavior/controls, the user taps on the smart object while the control device monitors wireless signals received from various smart objects to identify the signals exhibiting a microphonic “ding.” When a microphonic ding is detected in wireless signals received from one smart object, the control device can automatically associate or link the address of that smart object to the pertinent location/, behavior and/or controls identified by user through the user interface. With the association established and stored in memory, the control device can then control the smart object in accordance with settings or command received from the user.

In some embodiments, a user may select one or more controls or behaviors to be associated with one or more particular smart objects and then tap the associated smart objects to complete the association of the smart objects to the controls. The tapping may be designated to occur during a predetermined time interval to facilitate recognition of the microphonic ding by the control device. For example, the control device may establish a one minute interval during which the user must tap a smart object in order to associate the smart object with selected controls. The user may proceed to tap during the association interval. By establishing an interval, the control device can ignore spurious dings that may be received from the smart objects, such as noise, other vibrations and inadvertent contact with smart objects.

In some embodiments, the successful onboard of a smart object, including the identification of the smart object and association of the smart object with a control device, may be confirmed by the control device commanding the smart object to take an action, such as flashing a smart bulb on and off to provide a visual confirmation that it has been identified by the control device/network.

In some embodiments, a modulation of the wireless signal similar to that produced by the microphonic effect can be triggered from physical excitations of accelerometers, microphones, etc. within the smart object.

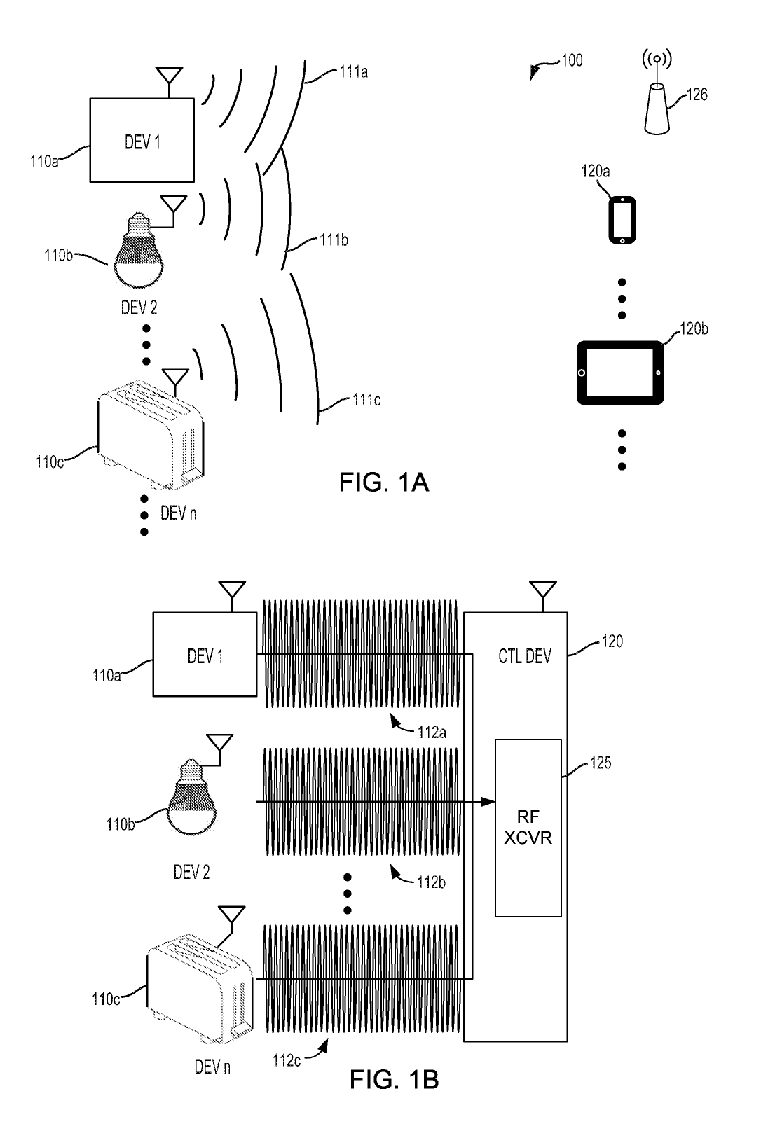

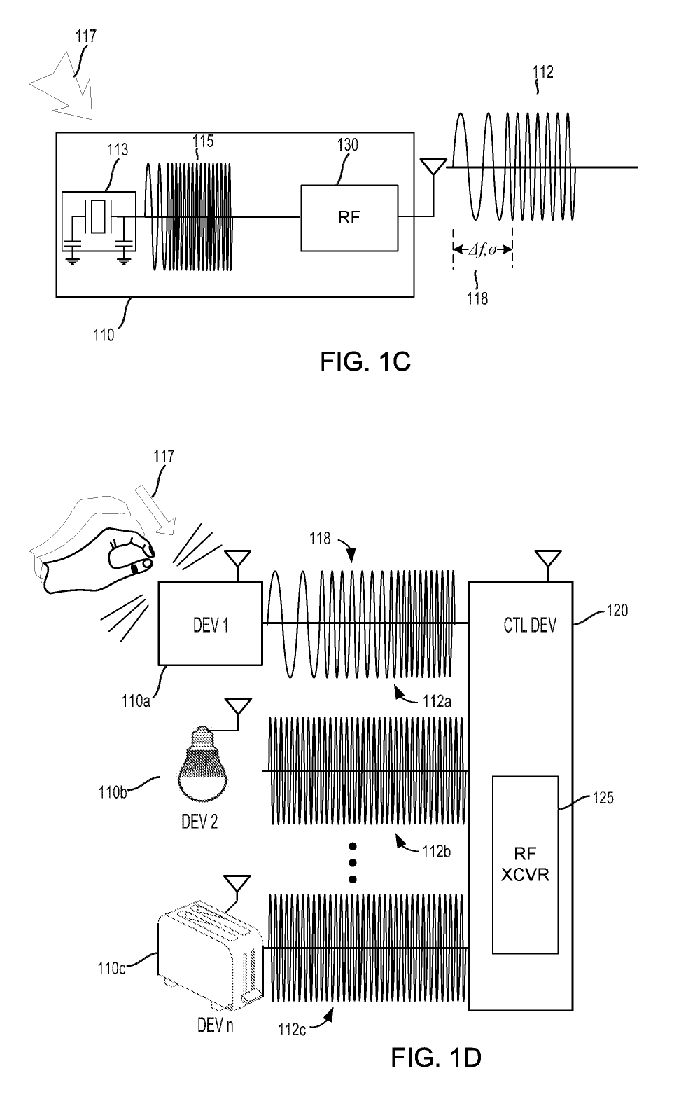

The various embodiments may be implemented within a variety of communication systems, such as the example communication network 100 illustrated in FIG. 1A. In an embodiment, a communication network 100 may include control devices 120a, 120b, such as a mobile communication device (e.g., smartphone, tablet, etc.). The control devices 120a, 120b may control one or more smart objects 110a-110c through wireless communication links 111a-111c. The wireless communication links 111a-111c may be established with an access point 126 (e.g., wireless access point, wireless router, etc.). In some implementations, the smart objects 110a-110c may connect with each other, either through a direct link or through a wireless communication link via a wireless network provided through the access point 126.

In the various embodiments, interconnections between the control devices 120a, 120b and the smart objects 110a-110c may be established through radio frequency signals as illustrated in FIG. 1B. For example, the smart objects 110a-110c may emit RF signals, such as output signals 112a-112c that are received by one or more of the control devices 120a, 120b. For example, the control device 120 may be provided with an RF transceiver 125. The RF transceiver 125 may be configured to receive the output signals 112a-112c from the smart objects 110a-110c.

As illustrated in FIGS. 1C and 1D, the output signal of the smart objects 110a-110c may be affected by a tap to produce a microphonic “ding” as vibrations caused by the tap effect transmitter components of the smart objects 110a-110c. For example, the smart objects 110a-110c may include a reference frequency unit or crystal oscillator, such as reference frequency unit 113. The reference frequency unit 113 may generate a reference frequency signal 115 that is provided to an RF unit 130 of the smart object 110. The RF unit 130 may have other elements that are not shown for ease of description, such as mixers, baseband sections, etc. FIG. 1C illustrates that the reference frequency unit 113 and the reference frequency signal 115 are used by the RF unit 130, directly or indirectly, to produce the output signal 112. When the smart object 110 experiences a physical excitation 117, such as a tap from a user, the reference frequency unit 113 may be disturbed and produce variations in the reference frequency signal 115. The variations in the reference frequency signal 115 may propagate through the RF unit 230 and produce frequency and/or phase variations as a microphonic modulation component 118 in the output signal 112.

Thus, as illustrated in FIG. 1D, the user may tap on one of the smart objects 110a to produce a physical excitation 117 that causes the output signal 112a to contain the microphonic modulation component 118. The RF transceiver 125 may be configured to detect the microphonic modulation component 118. In particular, the RF transceiver 125 may be configured such that the microphonic modulation component 118 can be distinguished from normal modulation of transmitted signals 112b, 112c. By recognizing the microphonic modulation component 118 imparted on the output signal 112a from the physical excitation 117, the control device 120 may distinguish the tapped one of the smart objects 110a from the other ones of the smart objects 110b and 110c with which the control device 120 may be communicating.

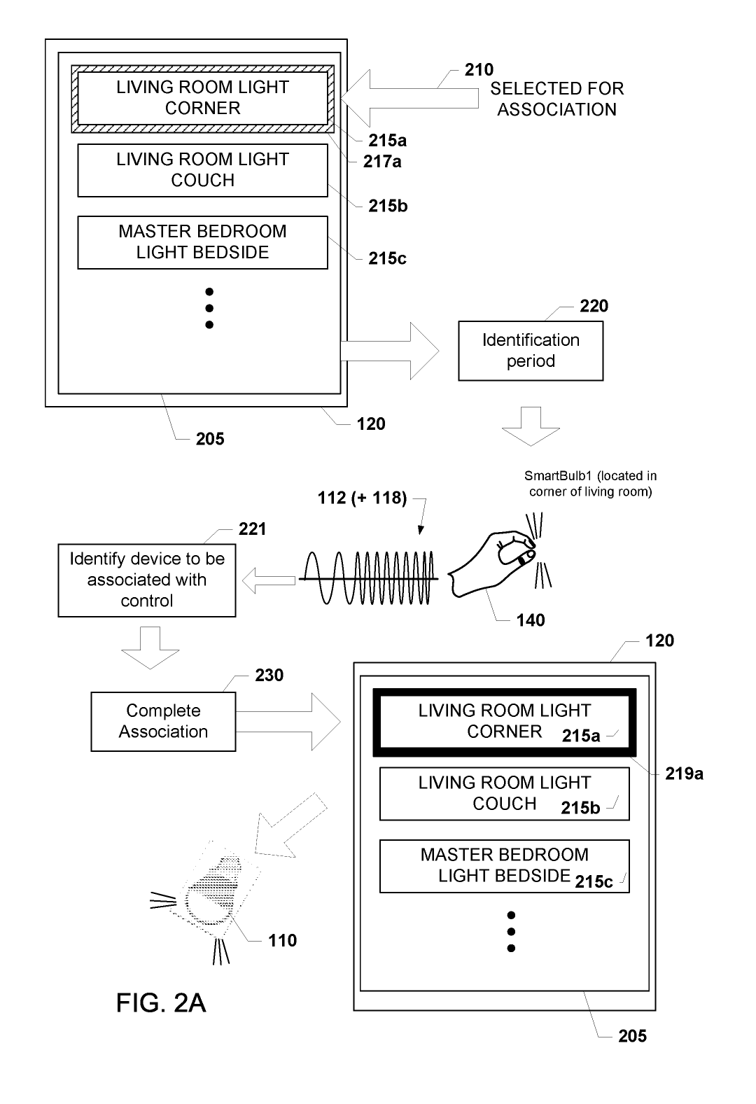

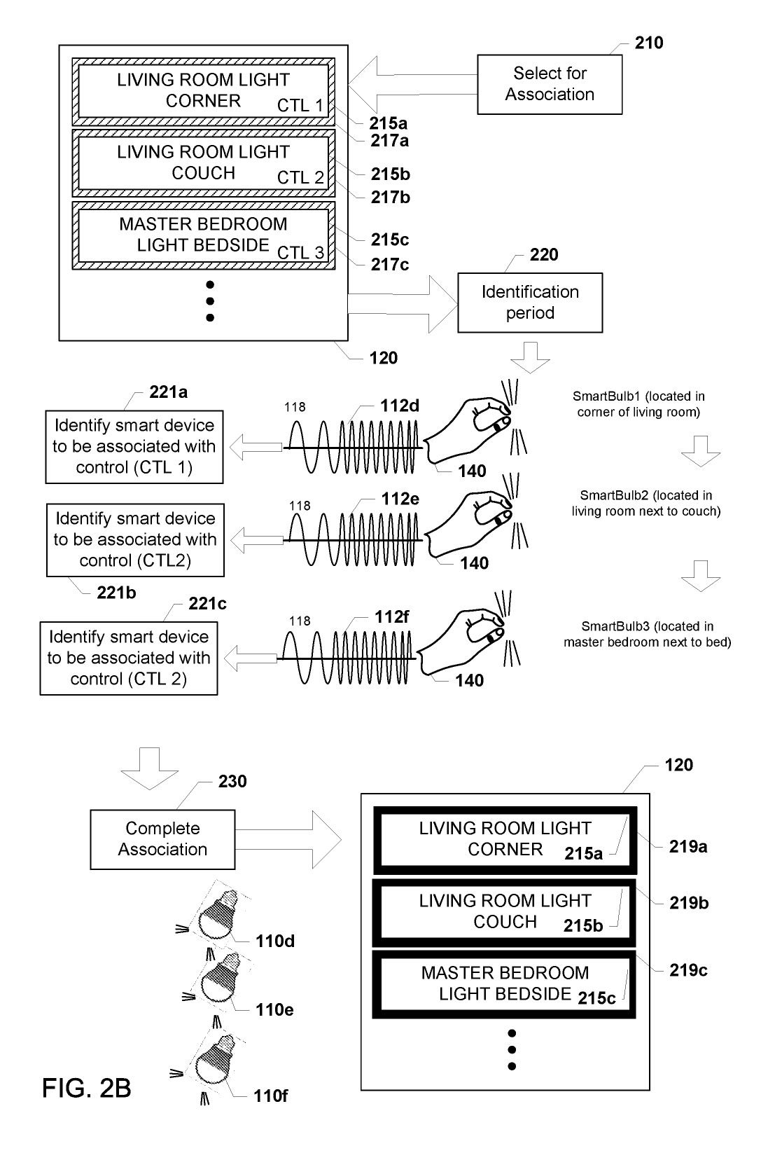

In the various embodiments, the control devices 120a, 120b may be provided with a user interface 205 to facilitate the onboarding process leveraging the microphonic effect as illustrated in FIG. 2A. The user interface 205 may include displays for 215a-215b that show certain objects with a presumptive location. For example, in FIG. 2A, display 215a corresponds to “LIVING ROOM LIGHT CORNER,” display 215b corresponds to “LIVING ROOM LIGHT COUCH,” and display 215c corresponds to “MASTER BEDROOM LIGHT BEDSIDE.” The displays 215a-215c may also correspond to controls for the designated light objects. For example, when the display 215a is selected in operation 210, the display 215a may be highlighted such as through a border highlight 217a that indicates that the display 215a has been selected for association.

In some embodiments, user selection of the display 215a may begin an identification period 220 during which the processor of control device is configured to expect to recognize a microphonic “ding” on the corresponding bulb, e.g. the bulb in the corner of the living room. During the identification period 220, the user 140 may tap the correct smart bulb, which due to the microphonic effect induced from the tap, the output signal 112 exhibits microphonic modulation, such as through the microphonic modulation component 118. In block 221, the control device may identify the smart object (e.g., SmartBulb1 located in the corner of the living room) as the smart object to be associated with the display 215a, which is highlighted with the border highlight 217a. The processor of the control device 120 may complete the association in block 230. The control device 120 may change the border highlight 217a to an indication 219a that the smart object indicated in the display 215a has been correctly associated. In addition, the control device may cause the smart bulb to blink in order to confirm that a correct association has been made.

In an embodiment illustrated in FIG. 2B, all displays 215a-215c corresponding to controls for all smart objects may all be selected in operation 210. In this circumstance, the displays 215a-215c may be highlighted, such as through border highlights 217a-217c, indicate that the displays 215a-215c have been selected for association. The selection of the displays 215a-215c may begin an identification period 220 during which the processor of control device is configured to expect to recognize the microphonic “dings” in the wireless signals of the corresponding smart objects 110d-110f. During the identification period 220, the user 140 may tap the correct bulbs, e.g. the smart objects 110d-110f (the bulbs). Due to the microphonic effect induced from the taps, the output signals 112d-112f may exhibit microphonic modulation through a microphonic modulation component 118 that the control device may identify in blocks 221a-221c. In response, the control device may associate each of the smart objects (e.g., SmartBulb1, SmartBulb2, SmartBulb3) with designated controls (e.g., CTL1, CTL2, CTL3) with the displays 215a-215c and border highlights 217a-217c. The processor of the control device 120 may complete the associations in block 230. The control device 120 may change the border highlights 217a-217c to indications 219a-219c indicating that the smart objects indicated in the displays 215a-215c have been correctly associated. In addition, the control device may cause the smart bulbs to blink in order to confirm that a correct association has been made for each.

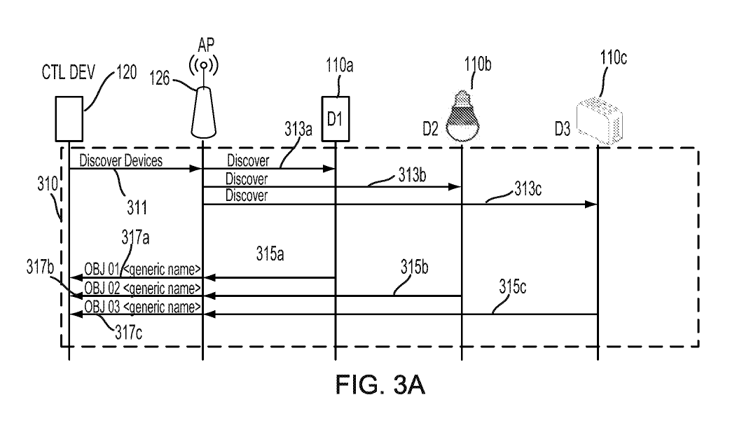

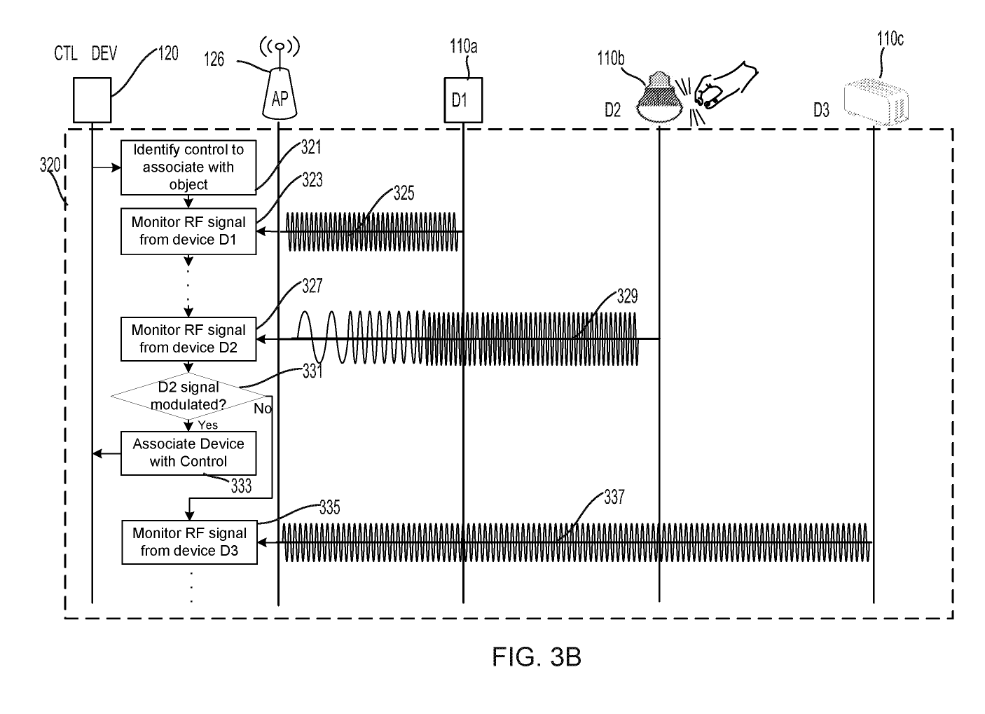

Communication between the control device 120 and the smart objects 110a-110c (smart object, smart lighting objects, smart appliance objects, etc.) are illustrated in FIG. 3A. In some embodiments, the control device 120 and the smart objects 110a-110c may communicate directly with each other via the exchange of wireless signals. In some embodiments, the control device 120 and the smart objects 110a-110c may communicate via a wireless network maintained through an access point 126.

In a message sequence 310, the control device 120 may transmit a discovery request message 311 to discover the smart objects 110a-110c. The discovery request message may be broadcast to all of the smart objects 110a-110c. In some embodiments, the smart objects 110a-110c may discover the control device 120. When an access point 126 is used, the access point 126 may forward the discovery request message 311 as discovery request messages 313a-313c to the smart objects 110a-110c.

In response to the discovery request messages 313a-313c, the smart objects 110a-110c may respond with messages 315a-315c that identify each smart object by its unique device identifier (e.g., MAC ID) or a generic name. For example the smart object D1 110a may respond as “OBJ 01,” 317a which represents the <generic name> of the smart object D1 110a. The smart object D2 110b may respond as “OBJ 02,” 317b which represents the <generic name> of the smart object D2 110b, and the smart object D3 110c, which may respond as “OBJ 03” 317c representing the <generic name> of the smart object D3 110c. When all of the smart objects 110a-110c are discovered, the control device 120 may display the generic names of the smart objects 110a-110c on a user interface display as discussed in connection with FIG. 2A and FIG. 2B. Because the smart objects 110a-110c have simply provided their name, there is no way for the control device 120 to apply any association between the smart objects and their location or behaviors/controls that user desires for each smart object. Therefore, any controls for the smart objects 110a-110c, which are intended to be associated with the specific location of the smart objects 110a-110c is not possible.

As illustrated in FIG. 3B, various embodiments enable smart objects to be specifically identified and associated with controls. For example, in the message sequence 320, the control device 120, may identify a control to be associated with a particular smart object in block 321. For example, as discussed herein in connection with FIG. 2A and FIG. 2B, the processor of the control device 120 may present a user interface through which a user may select a control to be associated with a specific object. The processor of the control device 120 may monitor the RF signals from the smart objects 110a-110c. For example, the processor of the control device 120 may monitor an RF signal 325 from a first smart object D1, the smart object 110a in block 323. The processor of the control device 120 may monitor an RF signal 329 from a second smart object D2, the smart object 110b in block 327. The processor of the control device may continue monitoring the RF signals from the smart objects 110a-110c while conducting communications with the smart objects during normal operation.

In determination block 331, the processor of the control device 120 may determine whether the RF signal 329 from smart object D2, the smart object 110b is exhibiting microphonic modulation. In response to determining that the RF signal 329 from smart object D2, the smart object 110b is exhibiting microphonic modulation (i.e., determination block 331=“Yes”), the processor of the control device may associate the smart object 110b with the identified control in block 333. In response to determining that the RF signal 329 from smart object D2, the smart object 110b is not exhibiting microphonic modulation (i.e., determination block 331=“No”), the processor of the control device may continue monitoring the RF signal 337 from the smart object D3, the smart object 110c in block 335.

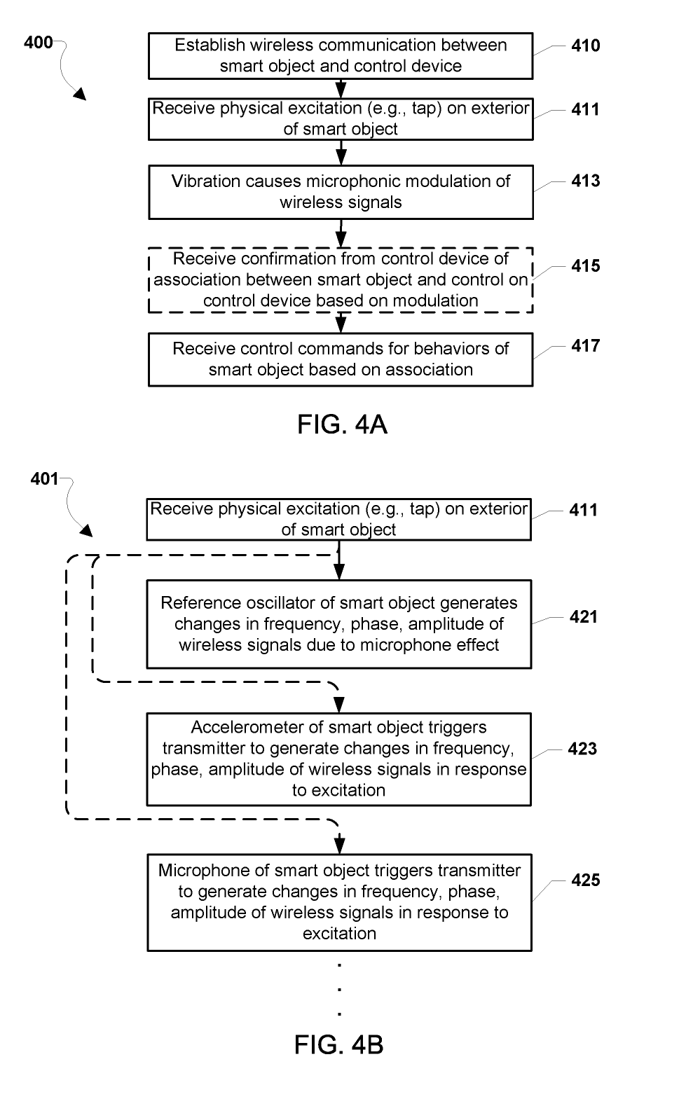

A method 400 that may be executed in smart objects according to various embodiments is illustrated in FIG. 4A. In block 410, a processor of the smart object may establish wireless communication between the smart objects and the control device.

In block 411, a physical excitation (e.g., a tap) on the smart object may be received. In block 413, the vibration from the tap may cause a microphonic modulation of the RF signal transmitted from the smart object. In an optional block 415, the processor of the smart object may receive a confirmation from the control device or from the associated control of the control device. In block 417, the processor of the smart object may receive control commands for behaviors of the smart object based on the association enabled by the microphonic modulation.

A method 401 that may be executed in smart objects according to various embodiments is illustrated in FIG. 4B. In block 411, the smart object may generate modulated output signals in response to a physical excitation, such as a user tap on the object. In block 421, the reference frequency oscillator, such as a crystal oscillator, may generate changes in frequency or phase of wireless signals due to the microphonic effect in block 421.

Alternatively, in block 423, in response to receiving a physical excitation such as a tap in block 411, the physical excitation may be detected by an accelerometer of the smart object. The smart object may be configured to generate recognizable modulations in the frequency and phase of the RF signal transmitted to the control device in response to a signal from the accelerometer. The perturbations in the transmitted signals may be similar to the microphonic effect.

Alternatively, in block 425, in response to receiving a physical excitation such as a tap in block 411, the physical excitation may be detected by a microphone of the smart object. The smart object may be configured to generate recognizable modulations in the frequency and phase of the RF signal transmitted to the control device in response to a signal from the microphone. The perturbations in the transmitted signals may be similar to the microphonic effect.

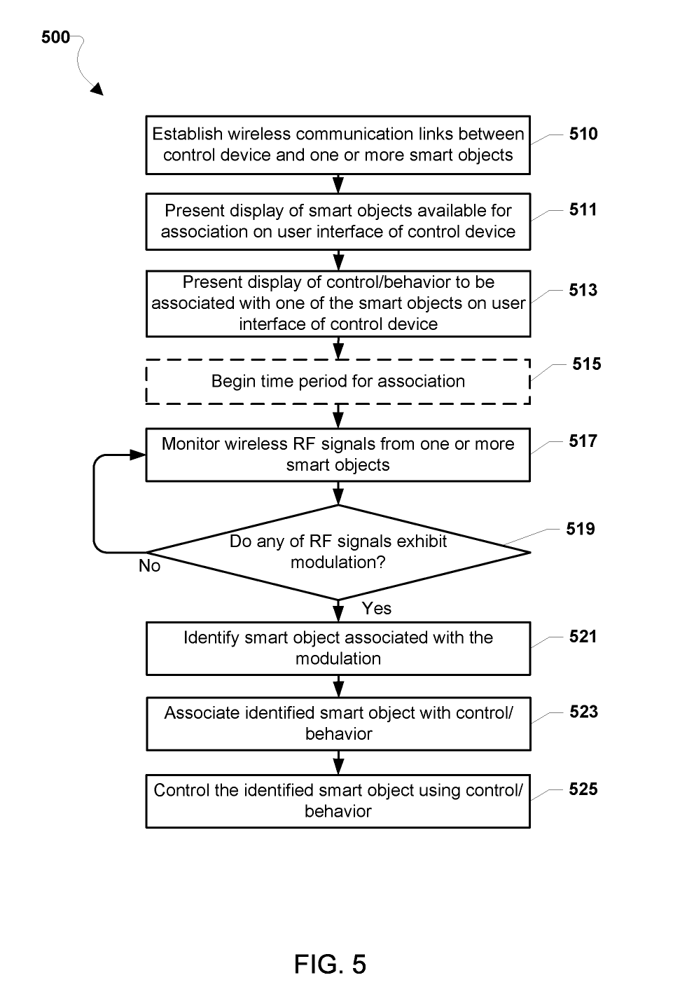

A method 500 for onboarding a smart object according to various embodiments is illustrated in FIG. 5. The method 500 may be implemented by a processor of a controlling computing device, such as a smartphone or other computing device configured to communicate with a plurality of smart objects via wireless communications.

In block 510, the processor of the control device may establish a wireless communication link between one or more smart objects. This process may involve well known handshaking operations to exchange smart object identifiers and negotiate communication parameters to enable the control device to recognize wireless signals received from each smart object.

In block 511, the processor of the control device may present a display, such as a user interface display that identifies (e.g., lists) smart objects available for association with various controls (e.g., on, off, dim, etc.).

In block 513, the processor of the control device may present a display, such as on the user interface of the control device, of a control or a behavior to be associated with one of the smart objects. The presentation may include a highlight of a particular control to be associated, such as based on an interaction between the user of the control device and the user interface in which the user selects a control for association. The user interface display may include instructions directing the user to tap the smart object that is to be associated with the selected control or behavior.

In block 515, the processor of the control device may optionally begin a time period for the association. For example, the time period may be a monitoring time period during which the control device monitors received wireless signals for the microphonic modulation effect. The monitoring time period helps to avoid false detections due to spurious modulations (e.g., noise, random vibrations, etc.) that could be mistaken for the intended microphonic effect.

In block 517, the processor of the control device may monitor the RF signals from the smart objects associated with the communication links between the smart objects and the control device. For example, the processor of the control device may be programmed or otherwise configured with modulation parameters that indicate the microphonic effect. The parameters may include one or more of a frequency deviation, phase deviation indicative of the microphonic effect. The parameters may also include a time window during which the deviations are expected to occur. The processor may also be configured to examine the modulation patterns over time to recognize a characteristic profile associated with the decaying vibrations following a sharp tap in order to distinguish microphonic modulations due to background vibrations.

In determination block 519, the processor of the control device may determine whether any of the RF signals exhibit the microphonic effect, including within the optional time period. In response to determining that one or more of the RF signals does not exhibit the microphonic effect (i.e., determination block 519=“No”), the processor of the control device may continue to monitor the RF signals from the smart objects in block 517.

In response to determining that one or more of the RF signals exhibit the microphonic effect (i.e., determination block 519=“Yes”), the processor of the control device may identify the smart object exhibiting microphonic modulation in block 521. For example, the processor of the control device may know the generic or object name associated with the smart object from which the modulated signal was received.

In block 523, the processor of the control device may associate the identified smart object with the control or behavior. For example, the processor may provide a logical link between an element of the control or behavior associated with the user interface, such as a functional element pointer with the identifier associated with the identified object. Additionally, control device may include associating a network label of the identified smart object with the selected control based on the user input.

In block 525, the processor of the control device may control the smart object using the control from the user interface of the control device. When the user presses the control on the user interface associated with the smart object various aspects of the smart object may be controlled, adjusted, operated, and so on. For example, when the user wants to turn on the light in the corner of the living room, the user may select the control associated with the light in the corner of the living room (which has now been properly associated), and turn on the proper light.

In some embodiments, the user may touch the control and smart object icons in block 513 in a series of user inputs indicating a sequence of controls to be associated with the plurality of smart objects and indicating the smart objects that the user will tap in a sequence, and then tap the smart objects in the indicated sequence. In such embodiments, the control device may associate each of the plurality of smart objects in the indicated sequence as microphonic modulations in transmitted wireless signals are received from each smart object.

In some embodiments, the display of smart objects available for associate presented on the control device in block 511 may be in the form of a map of a room or building indicating locations of smart objects. In such embodiments, the control device may indicate the map a location of the associated one of the plurality of smart object in response to detecting microphonic modulations in wireless signals of the communication link established with the associated smart object.

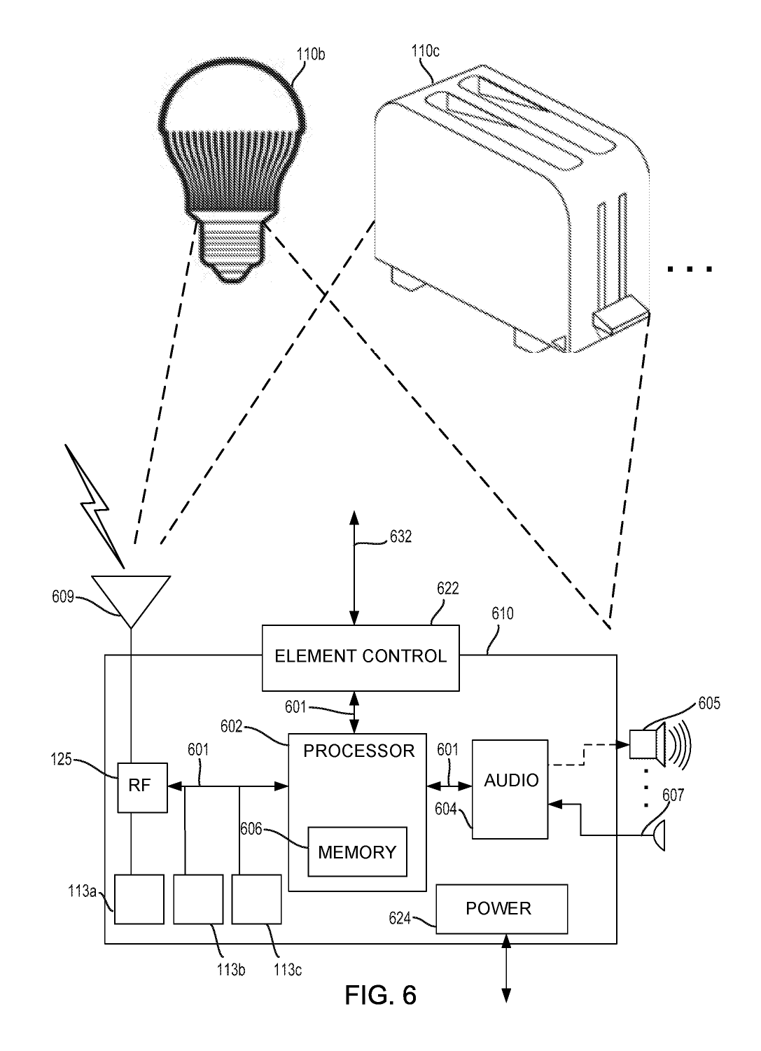

The smart objects described herein may be virtually any device (e.g., a light bulb or a toaster) may be converted into a smart object by provide the capability of connecting to a network, such as including a control and communication module (referred to as a “control unit”) 610. In various embodiments such as the embodiment 600 illustrated in FIG. 6, the smart objects may include a smart lighting object 110b, a smart toaster 110c, and other devices configured with communication and control elements 610. The smart objects 110b, 110c may include various controllable elements that may be controlled through an element control unit 622. In some embodiments, the smart objects 110b, 110c may include control lines 632 that enable the element control unit 622 to implement adjustments or control actions on the controllable elements of the smart object 110b, 110c.

The smart objects 110b, 110c may be equipped with a control unit 610, which may include at least a processor 602 and memory 606, an RF unit 125, an audio unit 604, an element control unit 622, and a power unit 624. The various units within the control unit 610 may be coupled through connections 601. The connections 601 may be a bus configuration that may include data lines, control lines, power lines, or other lines or a combination of lines.

The processor 602 may be configured with processor-executable instructions to execute at least various operations described herein including operations to implement commands received by a control device using the connection 601. The processor 602 may be an embedded processor or controller, a general purpose processor, or similar processor and may be equipped with internal and/or external memory 606. The internal/external memory 606 may be volatile or non-volatile memory, and may be secure and/or encrypted memory, or unsecure and/or unencrypted memory, or any combination thereof.

The RF unit 125 may have one or more radio signal transceivers (e.g., Peanut, Bluetooth, Bluetooth Low Energy (LE), ZigBee, Wi-Fi, RF radio, etc.) and may be coupled to or incorporate an antennae 609, for sending and receiving communications. The transceivers of the RF unit 125 may be coupled to each other and/or to the processor 602. The transceivers of the RF unit 125 and the antennae 609 may be used with the above-mentioned circuitry to implement the various wireless transmission protocol stacks and interfaces and may be controllable by at least a thin client version of the framework. As discussed herein, the RF unit 125 may receive a reference frequency from a reference frequency unit 113a (e.g. crystal oscillator) that may affect the modulation of an output signal of the RF unit 125 when perturbed or excited with a tap. The smart objects 110b, 110c may also be configured with an accelerometer 113b, or other responsive element 113c (e.g., a piezoelectric element).

The audio unit 604 may include a speaker or transducer 605 capable of transmitting audio signals. In some embodiments, the audio unit 604 may further include a microphone 607 for receiving sound signals. In alternative or additional embodiments, a tap on the microphone 607 may be used to generate a detectable modulation on the RF signal.

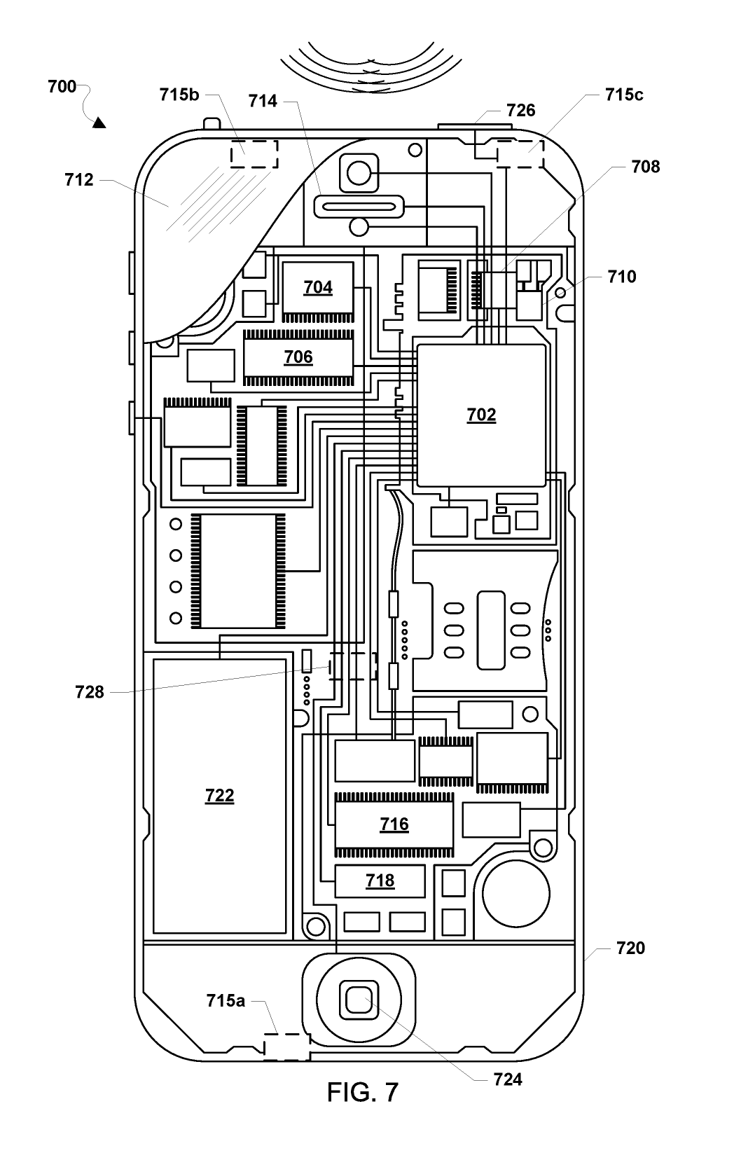

The various aspects related to the control device may be implemented in any of a variety of mobile computing devices (e.g., smartphones, tablets, etc.) an example of which is illustrated in FIG. 7. The mobile computing device 700 may include a processor 702 coupled the various systems of the mobile computing device 700 for communication with and control thereof. For example, the processor 702 may be coupled to a touch screen controller 704, radio communication elements, speakers and microphones, and an internal memory 706. The processor 702 may be one or more multi-core integrated circuits designated for general or specific processing tasks. The internal memory 706 may be volatile or non-volatile memory, and may be secure and/or encrypted memory, or unsecure and/or unencrypted memory, or any combination thereof. In another embodiment (not shown), the mobile computing device 700 may also be coupled to an external memory, such as an external hard drive.

The touch screen controller 704 and the processor 702 may also be coupled to a touch screen panel 712, such as a resistive-sensing touch screen, capacitive-sensing touch screen, infrared sensing touch screen, etc. Additionally, the display of the mobile computing device 700 need not have touch screen capability. The mobile computing device 700 may have one or more radio signal transceivers 708 (e.g., Peanut, Bluetooth, Bluetooth LE, ZigBee, Wi-Fi, RF radio, etc.) and antennae 710, for sending and receiving communications, coupled to each other and/or to the processor 702. The radio signal transceivers 708 and antennae 710 may be used with the above-mentioned circuitry to implement the various wireless transmission protocol stacks and interfaces. The mobile computing device 700 may include a cellular network wireless modem chip 716 that enables communication via a cellular network and is coupled to the processor.

The mobile computing device 700 may include a peripheral device connection interface 718 coupled to the processor 702. The peripheral device connection interface 718 may be singularly configured to accept one type of connection, or may be configured to accept various types of physical and communication connections, common or proprietary, such as USB, FireWire, Thunderbolt, or PCIe. The peripheral device connection interface 718 may also be coupled to a similarly configured peripheral device connection port (not shown).

In some embodiments, the mobile computing device 700 may include one or more microphones 715a-715c. For example, the mobile computing device may have a conventional microphone 715a for receiving voice or other audio frequency energy from a user during a call. The mobile computing device 700 may further be configured with additional microphones 715b and 715c, which may be configured to receive audio including ultrasound signals. Alternatively, all microphones 715a, 715b, and 715c may be configured to receive ultrasound signals. The microphones 715a-715c may be piezoelectric transducers, or other conventional microphone elements. In embodiments in which more than one microphone 715a-715c may be used, relative location information may be received in connection with a received ultrasound signal through various triangulation methods. At least two microphones 715a-715c configured to receive ultrasound signals may be used to generate position information for an emitter of ultrasound energy.

The mobile computing device 700 may also include speakers 714 for providing audio outputs. The mobile computing device 700 may also include a housing 720, constructed of a plastic, metal, or a combination of materials, for containing all or some of the components discussed herein. The mobile computing device 700 may include a power source 722 coupled to the processor 702, such as a disposable or rechargeable battery. The rechargeable battery may also be coupled to the peripheral device connection port to receive a charging current from a source external to the mobile computing device 700. The mobile computing device 700 may also include a physical button 724 for receiving user inputs. The mobile computing device 700 may also include a power button 726 for turning the mobile computing device 700 on and off.

In some embodiments, the mobile computing device 700 may further include an accelerometer 728, which senses movement, vibration, and other aspects of the device through the ability to detect multi-directional values of and changes in acceleration. In the various embodiments, the accelerometer 728 may be used to determine the x, y, and z positions of the mobile computing device 700. Using the information from the accelerometer, a pointing direction of the mobile computing device 700 may be detected.

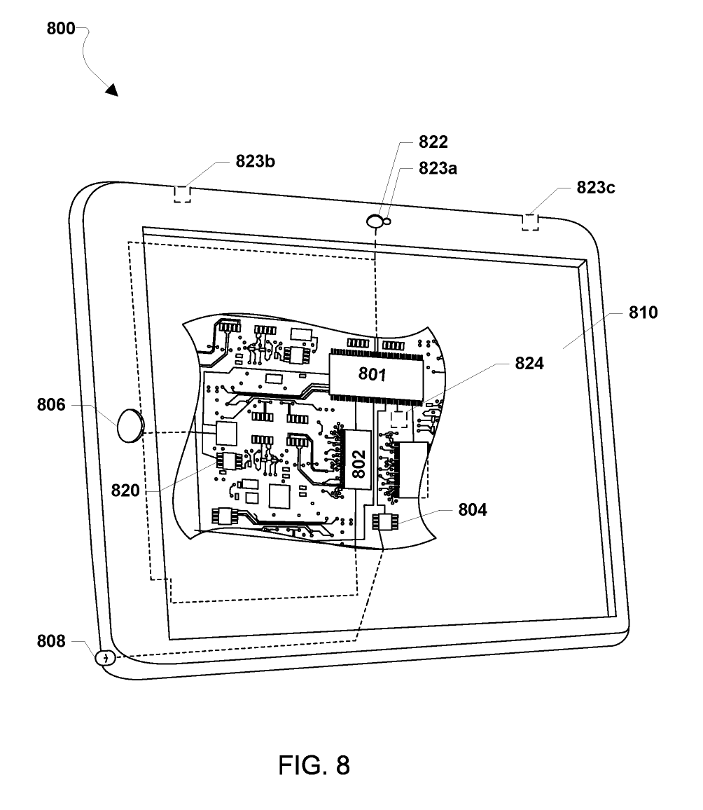

The various embodiments may be implemented in any of a variety of mobile computing devices, an example in the form of a tablet computing device is illustrated in FIG. 8. For example, a tablet computing device 800 may include a processor 801 coupled to internal memory 802. The internal memory 802 may be volatile or non-volatile memory, and may be secure and/or encrypted memory, or unsecure and/or unencrypted memory, or any combination thereof. The processor 801 may also be coupled to a touch screen display 810, such as a resistive-sensing touch screen, capacitive-sensing touch screen infrared sensing touch screen, etc. The tablet computing device 800 may have one or more radio signal transceivers 804 (e.g., Peanut, Bluetooth, ZigBee, WiFi, RF radio) and antennas 808 for sending and receiving wireless signals as described herein. The transceivers 804 and antennas 808 may be used with the above-mentioned circuitry to implement the various wireless transmission protocol stacks and interfaces. The tablet computing device 800 may include a cellular network wireless modem chip 820 that enables communication via a cellular network. The tablet computing device 800 may also include a physical button 806 for receiving user inputs. The tablet computing device 800 may also include various sensors coupled to the processor 801, such as a camera 822, a microphone or microphones 823a-823c, and an accelerometer 824.

For example, the tablet computing device 800 may have a conventional microphone 823a for receiving voice or other audio frequency energy from a user during a call or other voice frequency activity. The tablet computing device 800 may further be configured with additional microphones 823b and 823c, which may be configured to receive audio including ultrasound signals. Alternatively, all microphones 823a, 823b, and 823c may be configured to receive ultrasound signals. The microphones 823a-823c may be piezoelectric transducers, or other conventional microphone elements. Because more than one microphone 823a-823c may be used, relative location information may be received in connection with a received ultrasound signal through various methods such as time of flight measurement, triangulation, and similar methods. At least two microphones 823a-823c that are configured to receive ultrasound signals may be used to generate position information for an emitter of ultrasound energy.

In some embodiments, the tablet computing device 800 may further include an accelerometer 824 which senses movement, vibration, and other aspects of the tablet mobile computing device 800 through the ability to detect multi-directional values of and changes in acceleration. In the various embodiments, the accelerometer 824 may be used to determine the x, y, and z positions of the tablet mobile computing device 800. Using the information from the accelerometer 824, a pointing direction of the tablet mobile computing device 800 may be detected.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart lighting objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart lighting objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the following claims and the principles and novel features disclosed herein.

What is claimed is:

1. A method of associating a smart object with a control device in a wireless network, comprising:
monitoring wireless signals received from a plurality of smart objects to detect microphonic modulations in wireless signals transmitted by one of the plurality of smart objects;
presenting a user interface display requesting a user to identify a control to be associated with one of the plurality of smart objects;
receiving a user input identifying a selected control to be associated with one of the plurality of smart objects; and
associating the selected control with the one of the plurality of smart objects exhibiting microphonic modulations in transmitted wireless signals.

2. The method of claim 1, wherein monitoring wireless signals to detect microphone modulations is performed after receiving the user input identifying the selected control to be associated with the one of the plurality of smart objects.

3. The method of claim 1, wherein the user interface display includes instructions directing the user to tap the one of the plurality of smart objects with which the selected control is to be associated.

4. The method of claim 1, further comprising establishing communication links with each of the plurality of smart objects prior to monitoring wireless signals received from the plurality of smart objects.

5. The method of claim 4, wherein associating the selected control with the one of the plurality of smart objects exhibiting microphonic modulations in transmitted wireless signals comprises associating the selected control with a network label of the one of the plurality of smart objects exhibiting microphonic modulations in response to detecting microphonic modulations in wireless signals of the communication link established with the one of the plurality of smart objects.

6. The method of claim 4, wherein:
receiving a user input identifying a selected control to be associated with one of the plurality of smart objects comprises receiving a series of user inputs indicating selecting controls a sequence in which the user will tap the plurality of smart objects; and
associating the selected control with the one of the plurality of smart objects exhibiting microphonic modulations in transmitted wireless signals comprises sequentially associating each selected control with one of the plurality of smart objects exhibiting microphonic modulations in wireless signals of the established communication links.

7. The method of claim 4, wherein:
the user interface display includes a map of smart object locations; and
associating the selected control with the one of the plurality of smart objects exhibiting microphonic modulations in transmitted wireless signals comprises indicating on the map of smart object locations a location of the one of the plurality of smart objects exhibiting microphonic modulations in wireless signals of an established communication link.

8. A control device for controlling a smart object in a wireless network, comprising:
a transceiver; and
a processor coupled to the transceiver, the processor configured with processor-executable instructions for performing operations comprising:
monitoring wireless signals received from a plurality of smart objects to detect microphonic modulations in wireless signals transmitted by one of the plurality of smart objects;
presenting a user interface display requesting a user to identify a control to be associated with one of the plurality of smart objects;
receiving a user input identifying a selected control to be associated with one of the plurality of smart objects; and
associating the selected control with the one of the plurality of smart objects exhibiting microphonic modulations in transmitted wireless signals.

9. The control device of claim 8, wherein the processor is configured with processor executable instructions to perform operations such that monitoring wireless signals to detect microphone modulations is performed after receiving the user input identifying the selected control to be associated with the one of the plurality of smart objects.

10. The control device of claim 8, wherein the processor is configured with processor executable instructions to perform operations such that the user interface display includes instructions directing the user to tap the one of the plurality of smart objects with which the selected control is to be associated.

11. The control device of claim 8, wherein the processor is configured with processor executable instructions to perform operations further comprising establishing communication links with each of the plurality of smart objects prior to monitoring wireless signals received from the plurality of smart objects.

12. The control device of claim 11, wherein the processor is configured with processor executable instructions to perform operations such that associating the selected control with the one of the plurality of smart objects exhibiting microphonic modulations in transmitted wireless signals comprises associating the selected control with a network label of the one of the plurality of smart objects exhibiting microphonic modulations in response to detecting microphonic modulations in wireless signals of the communication link established with the one of the plurality of smart objects.

13. The control device of claim 11, wherein the processor is configured with processor executable instructions to perform operations such that:
receiving a user input identifying a selected control to be associated with one of the plurality of smart objects comprises receiving a series of user inputs indicating selecting controls a sequence in which the user will tap the plurality of smart objects; and
associating the selected control with the one of the plurality of smart objects exhibiting microphonic modulations in transmitted wireless signals comprises sequentially associating each selected control with one of the plurality of smart objects exhibiting microphonic modulations in wireless signals of the established communication links.

14. The control device of claim 11, wherein the processor is configured with processor executable instructions to perform operations such that:
the user interface display includes a map of smart object locations; and
associating the selected control with the one of the plurality of smart objects exhibiting microphonic modulations in transmitted wireless signals comprises indicating on the map of smart object locations a location of the one of the plurality of smart objects exhibiting microphonic modulations in wireless signals of an established communication link.

15. A control device for controlling a smart object in a wireless network, comprising:
means for monitoring wireless signals received from a plurality of smart objects to detect microphonic modulations in wireless signals transmitted by one of the plurality of smart objects;
means for presenting a user interface display requesting a user to identify a control to be associated with one of the plurality of smart objects;
means for receiving a user input identifying a selected control to be associated with one of the plurality of smart objects; and
means for associating the selected control with the one of the plurality of smart objects exhibiting microphonic modulations in transmitted wireless signals.

16. The control device of claim 15, wherein means for monitoring wireless signals to detect microphone modulations comprises means for monitoring wireless signals to detect microphone modulations after receiving the user input from means for receiving the user input identifying the selected control to be associated with the one of the plurality of smart objects.

17. The control device of claim 15, wherein the user interface display includes instructions directing the user to tap the one of the plurality of smart objects with which the selected control is to be associated.

18. The control device of claim 15, further comprising means for establishing communication links with each of the plurality of smart objects prior to monitoring wireless signals received from the plurality of smart objects.

19. The control device of claim 18, wherein associating the selected control with the one of the plurality of smart objects exhibiting microphonic modulations in transmitted wireless signals comprises means for associating the selected control with a network label of the one of the plurality of smart objects exhibiting microphonic modulations in response to detecting microphonic modulations in wireless signals of the communication link established with the one of the plurality of smart objects.

20. The control device of claim 18, wherein:
means for receiving a user input identifying a selected control to be associated with one of the plurality of smart objects comprises means for receiving a series of user inputs indicating selecting controls a sequence in which the user will tap the plurality of smart objects; and
means for associating the selected control with the one of the plurality of smart objects exhibiting microphonic modulations in transmitted wireless signals comprises means for sequentially associating each selected control with one of the plurality of smart objects exhibiting microphonic modulations in wireless signals of the established communication links.

21. The control device of claim 18, wherein:
the user interface display includes a map of smart object locations; and
means for associating the selected control with the one of the plurality of smart objects exhibiting microphonic modulations in transmitted wireless signals comprises means for indicating on the map of smart object locations a location of the one of the plurality of smart objects exhibiting microphonic modulations in wireless signals of an established communication link.

22. A non-transitory computer readable storage medium having stored thereon processor-executable instructions configured to cause a processor of a control device for controlling a smart object in a wireless network to perform operations comprising:
monitoring wireless signals received from a plurality of smart objects to detect microphonic modulations in wireless signals transmitted by one of the plurality of smart objects;
presenting a user interface display requesting a user to identify a control to be associated with one of the plurality of smart objects;
receiving a user input identifying a selected control to be associated with one of the plurality of smart objects; and
associating the selected control with the one of the plurality of smart objects exhibiting microphonic modulations in transmitted wireless signals.

23. The non-transitory computer readable storage medium of claim 22, wherein the processor-executable instructions are configured to cause the processor to perform operations such that monitoring wireless signals to detect microphone modulations is performed after receiving the user input identifying the selected control to be associated with the one of the plurality of smart objects.

24. The non-transitory computer readable storage medium of claim 22, wherein the processor-executable instructions are configured to cause the processor to perform operations such that the user interface display includes instructions directing the user to tap the one of the plurality of smart objects with which the selected control is to be associated.

25. The non-transitory computer readable storage medium of claim 22, wherein the processor-executable instructions are configured to cause the processor to perform operations further comprising establishing communication links with each of the plurality of smart objects prior to monitoring wireless signals received from the plurality of smart objects.

26. The non-transitory computer readable storage medium of claim 25, wherein the processor-executable instructions are configured to cause the processor to perform operations such that associating the selected control with the one of the plurality of smart objects exhibiting microphonic modulations in transmitted wireless signals comprises associating the selected control with a network label of the one of the plurality of smart objects exhibiting microphonic modulations in response to detecting microphonic modulations in wireless signals of the communication link established with the one of the plurality of smart objects.

27. The non-transitory computer readable storage medium of claim 25, wherein the processor-executable instructions are configured to cause the processor to perform operations such that:
receiving a user input identifying a selected control to be associated with one of the plurality of smart objects comprises receiving a series of user inputs indicating selecting controls a sequence in which the user will tap the plurality of smart objects; and
associating the selected control with the one of the plurality of smart objects exhibiting microphonic modulations in transmitted wireless signals comprises sequentially associating each selected control with one of the plurality of smart objects exhibiting microphonic modulations in wireless signals of the established communication links.

28. The non-transitory computer readable storage medium of claim 25, wherein the processor-executable instructions are configured to cause the processor to perform operations such that:
the user interface display includes a map of smart object locations; and
associating the selected control with the one of the plurality of smart objects exhibiting microphonic modulations in transmitted wireless signals comprises indicating on the map of smart object locations a location of the one of the plurality of smart objects exhibiting microphonic modulations in wireless signals of an established communication link.
